(19) United States
(12) Patent Application Publication
(10) Pub. No.: US 2002/0049958 A1
(43) Pub. Date: Apr. 25, 2002

(54) Logical synthesizing apparatus for converting a hardware functional description into gate-level circuit information

(75) Inventor: Takayoshi Shimazawa, Kawasaki-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: KABUSHIKI KAISHA TOSHIBA, Kawasaki-shi (JP)

(21) Appl. No.: 09/749,805

(22) Filed: Dec. 28, 2000

(30) Foreign Application Priority Data
Dec. 28, 1999 (JP) P11-375858

(51) Int. Cl. G06F 17/50

(52) U.S. Cl. 716/18; 716/3; 716/6

(57) ABSTRACT

In the disclosed invention, a module in the functional description is fractionalized according to functions, the functional description is converted into two hierarchies and then the fractionalized modules are rearranged so as to decrease a critical path; and the rearranged modules are grouped to generate an intermediate hierarchy and a logical synthesis and optimization processing and a place and route processing are executed using the functional description after the formation of the intermediate hierarchy.

### BACKGROUND OF THE INVENTION

1. Field of the Invention

The present invention relates to a logical synthesis apparatus, a logical synthesis method, a logical synthesis program for converting a hardware functional description into gate-level circuit information, and to a circuit manufacturing method for determining a layout in a circuit by conducting a logical synthesis and optimization processing and a layout and route processing to the hardware functional description and for manufacturing a circuit using layout information.

The present invention particularly relates to a technique for converting a hierarchical hardware functional description into a hierarchical structure suited for a layout processing before converting the hierarchical hardware functional description into a gate level by a logical synthesis and optimization processing, thereby suppressing the formation of a critical path and decreasing chip area.

2. Description of the Related Art

A series of processings for manufacturing an integrated circuit such as ASIC and ASSP and IP are normally carried out according to the following processing steps.

Namely, after creating a hardware functional description (to be referred to as ‘functional description’ hereinafter) having an arbitrary hierarchy in which the operation of a circuit to be manufactured and the flow of signals are described by RTL (Register Transfer Level), a logical synthesis and optimization processing is executed with this functional description used as an input and the functional description is converted into gate-level circuit information.

Thereafter, after designing a circuit layout such as the place, route and the like of modules in the circuit by a place and route processing, a timing analysis reflected by the capacitor component and resistance component after the circuit layout is executed. As a result of the timing analysis, if the designed circuit meets a desired specification, an actual circuit is manufactured using information on the layout.

In case of creating a functional description by the conventional circuit manufacturing processings, a circuit to be designed is converted into arbitrary logical hierarchies in units of functional blocks for many reasons including, for example, the difference in the definition of the circuit specification according to functional blocks, that functional blocks are optimal as units in which a plurality of people take responsibility of operation, that it is easy to examine the logic of a single unit and that functional blocks are easy to debug at the time of examining the overall circuit logic.

Further, the logical synthesis and optimization processing and the place and route processing are normally conducted by one of the methods of (1) a flat layout processing, (2) a hierarchical layout processing and (3) a flat layout processing using region designation. Now, these processing methods will be described briefly.

(1) Flat Layout Processing

A logical synthesis and optimization processing is executed by one of the methods of “executing this processing to chips en bloc” and “executing this processing for every functional block and then flattening the functional blocks at a top level by breaking obtained hierarchies” while using a chip-size virtual wiring load model. Thereafter, using a flat gate-level net list without hierarchies, a place and route processing is conducted to the entire chip en bloc.

(2) Hierarchical Layout Processing

Sub-hierarchies (a single functional block or a collection of a plurality of functional blocks) are provided under the chip level, and a logical synthesis and optimization processing is executed by one of the methods of “executing this processing to the chip en bloc while maintaining hierarchies” and “executing this processing for every functional block or sub-hierarchy and then connecting the functional blocks or sub-hierarchies at the top level” while using a virtual wiring load model based on the respective sub-hierarchies. Thereafter, a place and route processing is conducted to every sub-hierarchy and then the sub-hierarchies are connected at a chip level.

(3) Flat Layout Processing Using Region Designation

A logical synthesis and optimization processing is executed by one of the method of “executing this processing to the chip en bloc” and “executing this processing for every functional block or sub-hierarchy and then assembling the processing results at the top level, breaking the hierarchies flat” using a virtual load wiring model. Thereafter, using a flat gate-level net list, a place and route processing is conducted. In this processing, while the net list is flat, the names of the functional blocks before breaking the hierarchies are included in the name of instances in the net list. Place regions are limited by the functional block names and each region becomes a single functional block or a group of functional blocks.

Nevertheless, the above-stated conventional circuit manufacturing processings have the following technical disadvantages to be overcome:

First, in the conventional circuit manufacturing processings, the wire load model is employed for the logical synthesis and optimization processing and the place and route processing. The wire load model has the following problems.

In the wire load model, as shown in FIG. 1A, a wire load is defined as a function of fan-out (or way number, equivalent to the number of input pins in the next stage in which an outputted cell is driven) and the wire load is represented by one value according to the fan-out. Normally, actual wire loads spread widely from light and heavy loads particularly if the fan-out is 1 as shown in FIG. 1B.

Due to this, if the wire load model is applied to long wire and detoured wire which are provided when the fan-out is 1, an actual wire load is extremely deviated from the typical value toward heavy loads. As a result, a great error occurs between a delay value estimated from the wire load model and an actual delay value and timing restrictions satisfied by the wire load model cannot be satisfied after designing a circuit layout. Particularly, in the current circuit manufacturing processing, memories and macro-cells (IP) are arranged on the corner of the chip and a wire to an input pin and that from an output pin tend to be longer. Further, since the fan-out for the wire to the input pin tends to be 1 and that for the wire to the output pin tends to be 1 to 3, the wire delay error before and after designing the layout becomes greater further. In addition, in the hierarchical layout processing and the flat layout processing using region designation, instances of memories and macro-cells (IP) tend to be called and a cell for driving the memories and a macro-cell is optimized by the wire load model for sub-hierarchies or regions, so that the delay value is underestimated compared with an actual one.

Second, in the hierarchical layout processing and the flat layout processing using region designation, the shapes and place of sub-hierarchies and regions are determined in a cut-and-try manner in a floor plan phase. However, since the functional blocks are logically divided into hierarchies in such processings, it is difficult to eliminate signals transmitted and received among the functional blocks, with the result that many long wires and detoured wires are generated and critical paths are generated.

Third, in the flat layout processing, since the load wire model for the entire chip is employed, respective cells have excessively large driving capabilities, thereby disadvantageously increasing chip area. Further, if the chip area increases, the dispersion of loads relative to fan-out increases and it is difficult to express wire delay due to long wires and detoured wires using the wire load model, resulting in a large difference in wire delay between before and after layout. Besides, since the size of the chip capable of executing a place and route processing en bloc is restricted by the memory capacity, processing time and the like of the computer system, this technique is impractical for large-scale integrated circuits or LSI the development of which is now underway.

Fourth, in the hierarchical layout processing, since sub-hierarchies are constituted based on logical functional blocks, many signals transmitted and received among the sub-hierarchies exist. Normally, the wires of these signals largely rely on the positions of pins of the sub-hierarchies. Due to this, many unintended long wires and detoured wires are created. As a result, if using the wire load model, the difference in wire delay before and after designing the layout considerably grows.

Fifth, in the flat layout processing using region designation, since no pins exist in the regions, many long wires and detoured wires are not generated compared with the hierarchical layout processing. However, the regions are constituted based on the logical functional blocks, many signals are transmitted and received among the regions and unintended long wires and detoured wires are generated, with the result that the difference in wire delay grows before and after designing the layout.

As can be seen, according to the conventional circuit manufacturing processings, many critical paths are formed in the circuit and it is difficult to decrease chip area. In addition, since the delay value is estimated while applying the wirie load model to the formed critical paths, wire delay greatly differs before and after the layout and erroneous layout information is supplied to circuit manufacturers. Thus, it is difficult to manufacture a circuit which satisfies a desired specification.

### SUMMARY OF THE INVENTION

The present invention has been made in view of the above-stated technical disadvantages. It is an object of the present invention to provide a logical synthesis apparatus capable of suppressing the formation of a critical path in a circuit and reducing chip area.

It is another object of the present invention to provide a logical synthesis method capable of suppressing the formation of a critical path in a circuit and reducing chip area.

It is yet another object of the present invention to provide a logical synthesis program product for suppressing the formation of a critical path in a circuit and reducing chip area.

It is yet another object of the present invention to provide a circuit manufacturing method capable of suppressing the formation of a critical path in a circuit and reducing chip area.

To address the above-stated technical disadvantages, the inventor of the present invention contrived an idea that before converting a functional description into a gate level by a logical synthesis and optimization processing, a module in the functional description is fractionalized according to functions, the functional description is converted into two hierarchies and then the fractionalized modules are rearranged so as to decrease a critical path; and the rearranged modules are grouped under a predetermined condition under which a wire load model works to generate an intermediate hierarchy and a logical synthesis and optimization processing and a place and route processing are executed using the functional description after the formation of the intermediate hierarchy, whereby the critical path in the circuit can be improved and the chip area can be reduced. Finally, after continuing intensive studies, the inventor of the present invention reached a technical concept having the following features.

First, the present invention is characterized by a logical synthesis apparatus comprising: a fractionalization unit for fractionalizing a module defined in a hardware functional description according to functions, and for generating fractionalized modules; a hierarchical unit for converting the hardware functional description into two hierarchies; a rearrangement unit for rearranging the fractionalized modules so as to decrease detoured wires and long wires; a grouping unit for grouping the rearranged fractionalized modules under a predetermined condition under which a wire load model works, and for generating an intermediate hierarchy in the hardware functional description converted into two hierarchies; and a unit for conducting logical synthesis processing to the hardware functional description in which the intermediate hierarchy has been generated.

Thus, it is possible to suppress the formation of the critical path in the circuit and to reduce the chip area.

Second, the present invention is characterized by a logical synthesis method comprising the steps of: a fractionalization processing step of fractionalizing a module defined in a hardware functional description according to functions, and of generating fractionalized modules; a hierarchical processing step of converting the hardware functional description into two hierarchies; a rearranging processing step of rearranging the fractionalized modules so as to decrease detoured wires and long wires; a grouping processing step of grouping the rearranged fractionalized modules under a predetermined condition under which a wire load model works, and of generating an intermediate hierarchy in the hardware functional description converted into two hierarchies; and a step of conducting logical synthesis processing to the hardware functional description in which the intermediate hierarchy has been generated.

Thus, it is possible to suppress the formation of the critical path in the circuit and to reduce the chip area.

Third, the present invention is characterized by a logical synthesis program product for converting a hardware functional description into gate-level circuit information comprising: a computer readable program code for fractionalizing a module defined in a hardware functional description according to functions, and for generating fractionalized modules; a computer readable program code for converting the hardware functional description into two hierarchies; a computer readable program code for rearranging the fractionalized modules so as to decrease detoured wires and long wires; a computer readable program code for grouping the rearranged fractionalized modules under a predetermined condition under which a wire load model works, and for generating an intermediate hierarchy in the hardware functional description converted into two hierarchies; and a computer readable program code for conducting logical synthesis processing to the hardware functional description in which the intermediate hierarchy has been generated.

Thus, it is possible to suppress the formation of the critical path in the circuit and to reduce the chip area.

Fourth, the present invention is characterized by a logical synthesis apparatus comprising: a fractionalization unit for fractionalizing a module defined in a hardware functional description according to functions, and for generating fractionalized modules; a rearrangement unit for rearranging the fractionalized modules so as to decrease detoured wires and long wires; and a unit for conducting a logical synthesis processing to the rearranged hardware functional description.

Thus, it is possible to suppress the formation of the critical path in the circuit and to reduce the chip area even for the hardware description in which an entire chip is described by one module (module-endmodule) from the beginning.

Fifth, the present invention is characterized by a logical synthesis method comprising the steps of: a fractionalization processing step of fractionalizing a module defined in a hardware functional description according to functions, and of generating fractionalized modules; a rearrangement processing step of rearranging the fractionalized modules so as to decrease detoured wires and long wires; and a step of conducting a logical synthesis processing to the rearranged hardware functional description.

Thus, it is possible to suppress the formation of the critical path in the circuit and to reduce the chip area even for the hardware description in which an entire chip is described by one module (module-endmodule) from the beginning.

Sixth, the present invention is characterized by a logical synthesis program product for converting a hardware functional description into gate-level circuit information comprising: a computer readable program code for fractionalizing a module defined in a hardware functional description according to functions, and for generating fractionalized modules; a computer readable program code for rearranging the fractionalized modules so as to decrease long wires and detoured wires; and a computer readable program code for conducting a logical synthesis processing to the rearranged hardware functional description.

Thus, it is possible to suppress the formation of the critical path in the circuit and to reduce the chip area even for the hardware description in which an entire chip is described by one module (module-endmodule) from the beginning.

Seventh, the present invention is characterized by a circuit manufacturing method of determining a layout in a circuit by conducting a logical synthesis and optimization processing and a place and route processing to a hardware functional description, and manufacturing the circuit using layout information, the method comprising the steps of: a fractionalization processing step of fractionalizing a module defined in a hardware functional description according to functions, and of generating fractionalized modules; a hierarchical processing step of converting the hardware functional description into two hierarchies; a rearrangement processing step of rearranging the fractionalized modules so as to decrease long wires and detoured wires; a grouping processing step of grouping the rearranged fractionalized modules under a predetermined condition under which a wire load model works, and of generating an intermediate hierarchy in the hardware functional description converted into two hierarchies; a step of determining the layout in a circuit by conducting logical synthesis processing, optimization processing, and a place and route processing to said hardware functional description in which the intermediate hierarchy has been generated ; and a step of manufacturing the circuit using the determined layout information.

Thus, it is possible to suppress the formation of the critical path in the circuit and to reduce the chip area.

Preferably, a critical path formed in the circuit is identified by a timing analysis, and the fractionalized modules are rearranged while referring to information on the critical path.

By doing so, it is possible to efficiently suppress the formation of the critical path in the circuit.

Further, the grouping processing may be conducted so that the restriction to chip area is satisfied and the number of wires on the intermediate hierarchy is reduced if forming the intermediate hierarchy.

Thus, the number of wires provided among the modules can be reduced and the formation of the critical path can be suppressed.

Other and further objects and features of the present invention will become obvious upon understanding of the illustrative embodiments about to be described in connection with the accompanying drawings or will be indicated in the appended claims, and various advantages not referred to herein will occur to one skilled in the art upon employing of the invention in practice.

### BRIEF DESCRIPTION OF THE DRAWINGS

FIG. 1 is an explanatory view for a virtual wiring load model;

FIG. 2 is a block diagram showing the constitution of a circuit manufacturing system in one embodiment according to the present invention;

FIG. 3 is a flow chart showing a circuit manufacturing method in the embodiment according to the present invention;

FIG. 4 is an outside view of the circuit manufacturing system in the embodiment according to the present invention;

FIG. 5 is a typical view for describing a circuit hierarchical structure;

FIG. 6 is a floor plan view of the circuit before a fractionalization processing is conducted in the embodiment according to the present invention;

FIG. 7 is an explanatory view for the fractionalization processing in the embodiment according to the present invention;

FIG. 8 is a floor plan view of the circuit after the fractionalization processing is conducted in the embodiment according to the present invention;

FIG. 9 is a floor plan view of the circuit after a two-hierarchy conversion processing in the embodiment according to the present invention;

FIG. 10 is a floor plan view of the circuit after a rearrangement processing is conducted in the embodiment according to the present invention; and

FIG. 11 is a floor plan view of the circuit after a grouping processing is conducted in the embodiment according to the present invention.

### DETAILED DESCRIPTION OF THE PREFERRED EMBODIMENTS

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

First, description will be given to the constitution of a circuit manufacturing system in one embodiment according to the present invention.

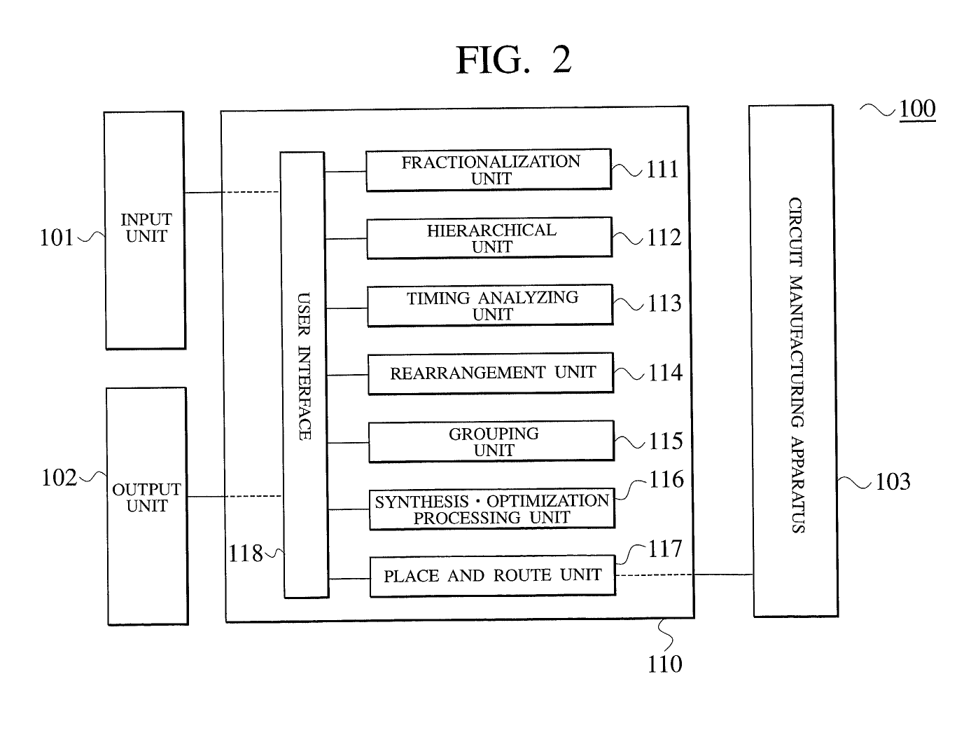

FIG. 2 is a block diagram showing the constitution of the circuit manufacturing system in the embodiment according to the present invention.

As shown in FIG. 2, the circuit manufacturing system in one embodiment according to the present invention consists of a circuit design apparatus 110 determining the layout of a circuit to be manufactured based on the functional description of the circuit to be manufactured, and a circuit manufacturing apparatus for manufacturing a mask pattern and the like and actually manufacturing a circuit based on information on the layout determined by the circuit design apparatus 110.

The circuit design apparatus 110 according to the embodiment of the present invention is comprised of fractionalization unit 111 for fractionalizing modules in an inputted functional description according to functions and generating a plurality of new modules (fractionalized modules), hierarchical unit 112 for converting the functional description after a fractionalization processing into two hierarchies, timing analysis unit 113 for executing a timing analysis based on place and route information from the place and route unit 117 and identifying a critical path existing in a circuit, rearrangement unit 114 for rearranging the fractionalized modules so as to decrease long wires and detoured wires (i.e., to shorten the wire length of the critical path), grouping unit 115 for grouping the rearranged fractionalized modules and for generating an intermediate hierarchy, synthesis and optimization unit 116 for converting the functional description into a gate level, place and route unit 117 for determining a circuit layout using the functional description converted into the gate level, and a user interface 118 assisting in user's controlling constituent elements in the circuit design apparatus 110. Here, the user interface 118 is preferably a graphical user interface (GUI) assisting in controlling the constituent elements by graphical display through an output section 112.

Further, the circuit design apparatus 110 in the embodiment according to the present invention is connected to an input unit 101 inputting specification information on a circuit to be manufactured and the like such as parameters for controlling the circuit design apparatus 110 and positional information on pads and pins, and connected to an output unit 102 outputting output information and error information on the circuit design apparatus 310 such as layout information. The input unit 101 may preferably be a keyboard or a mouse pointer, and the output section 102 may preferably be a display or a printer.

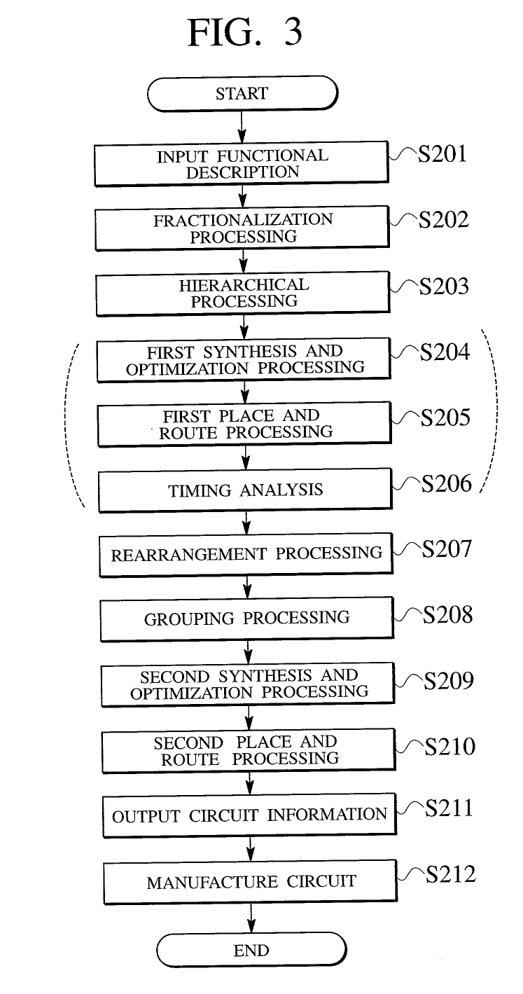

Next, a circuit manufacturing method in the embodiment according to the present invention will be described with reference to FIG. 3.

FIG. 3 is a flow chart showing the circuit manufacturing method in the embodiment according to the present invention.

A series of circuit manufacturing processings using the circuit manufacturing method in the embodiment according to the present invention are executed according to the following steps.

(1) A functional description in which the operation of a circuit to be manufactured and a signal flow are described by RTL is inputted into the circuit design apparatus 110 through the input section 101 (in a functional description input step or S201 ).

(2) The fractionalization unit 111 fractionalizes the modules in the inputted functional description according to functions and generates fractionalized modules (in a fractionalization step or S202 ). Here, in the fractionalization processing in this embodiment, if the inputted functional description is Verilog-RTL, ‘assign’ sentences and ‘always’ blocks in the description are retrieved and the functions designated by the respective sentences and blocks are fractionalized as new modules. It is noted that the functional description is not limited to Verilog-RTL and may be, for example, VHDL.

(3) The hierarchical unit 112 converts the functional description into two hierarchies (in a hierarchical processing step or S203 ).

(4) The synthesis and optimization unit 116 executes a logical synthesis and optimization processing using the two-hierarchical functional description (in the first synthesis and optimization processing step or S204 ).

(5) The place and route unit 117 conducts a flexible place and route processing, and determines the place and routes of the modules in the circuit (in the first place and route processing step or S205 ).

(6) The timing analysis unit 113 executes a timing analysis based on place and route information, and identifies a critical path existing in the circuit (in a timing analysis step or S206 ).

(7) The rearrangement unit 114 rearranges the fractionalized modules so as to decrease detoured wires and long wires while referring to positional information on pads, memories, IP and pins, and the identified critical path (in a rearrangement processing step or S207 ).

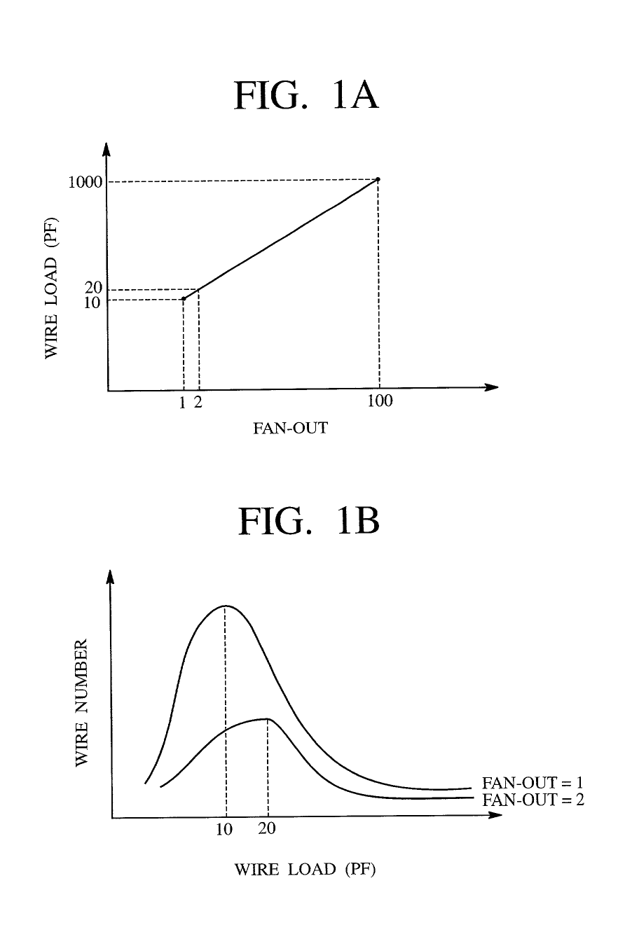

(8) The grouping unit 115 divides the rearranged modules into groups (about several tens gate) to the extent to which a wire load model can actually works, and generates an intermediate hierarchy (in a grouping processing step or S208 ). Normally, if a unit for executing synthesis and optimization is larger, the distribution of wire loads (FIG. 1B) described in ‘Related Art’ part turns into a state having a gentle peak and a wide plane. If actual wires are far from the wire load model and the unit is smaller, the wire load distribution turns into a state having a sharp peak to thereby make the wires closer to the wire load model. Namely, the smaller the synthesis and optimization execution unit is, the more accurately the wire load model can be utilized. Based on this, in the circuit manufacturing method in the embodiment according to the present invention, the wire load distribution state turns into a sharp state having a sharp peak and the modules rearranged into about several tens of gates are grouped so that the wire load model actually functions and then the synthesis and optimization processing is executed. The grouping processing may be conducted so that the restriction to chip area set in advance is satisfied and the number of wires on the intermediate hierarchy is reduced if forming the intermediate hierarchy.

(9) The synthesis and optimization unit 116 executes a logical synthesis and optimization processing using the functional description after generating the intermediate hierarchy (in the second synthesis and optimization processing step or S209 ).

(10) The place and route unit 117 determines a circuit layout (in the second place and route processing step or S210 ).

(11) The place and route unit 177 outputs information on the determined layout to the circuit manufacturing apparatus 103 (in a circuit information output step or S211 ).

(12) The circuit manufacturing apparatus 103 manufactures a circuit by conventional manufacturing method using the determined layout. For example, the circuit manufacturing apparatus 103 creates the mask pattern of the circuit to be manufactured based on the layout information from the circuit design apparatus 110 (in a circuit manufacturing step or S212 ).

It is noted that the above-stated first synthesis and optimization processing step S204 and the first place and route processing step S205 are required to identify a critical path. Therefore, if information on the critical path is obtained by other means, these two steps may be omitted.

As can be understood from the above, according to the circuit manufacturing system and the method thereof in the embodiment according to the present invention, the hardware functional description having arbitrary hierarchies is converted into a hierarchical structure suited for the circuit layout before being converted into a gate level by the logical synthesis and optimization processing. This makes it possible to suppress the formation of detoured wires and long wires and to reduce chip area. The “hierarchical structure suited for the circuit layout” means herein a structure which satisfies the following: (1) the highest hierarchy is a connection description for connection between memories, IP and the synthesis and optimization section (sub-modules); (2) the number of wires between the memories, IP and the sub-modules is low; and (3) a sequential cell (flip-flop or latch) does not serve as a terminal end and the number of signals requiring wires between sub-modules twice or more is low.

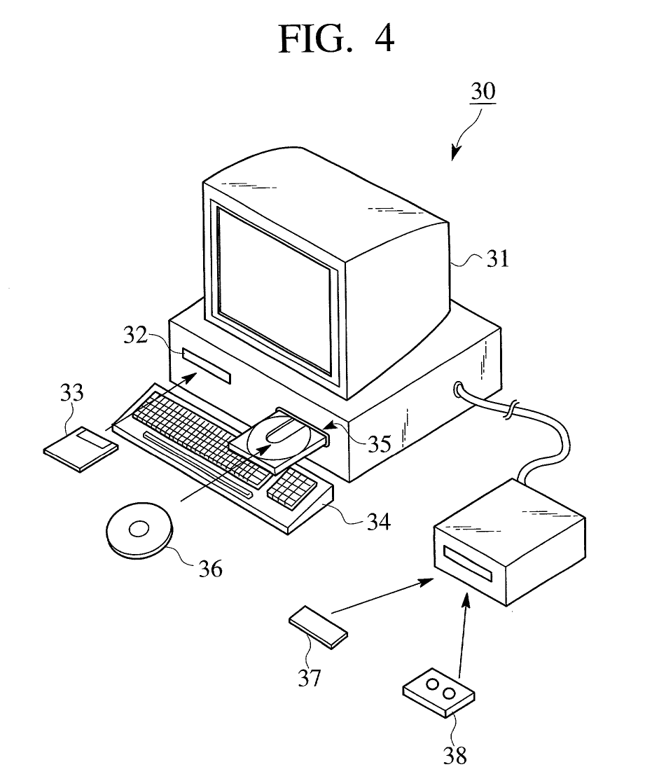

The circuit design apparatus in the embodiment according to the present invention has an outside view as shown in, for example, FIG. 4. That is, the circuit design apparatus in the embodiment according to the present invention is constituted by incorporating the respective constituent elements of the circuit design apparatus into a computer system 30. The computer system 30 comprises a floppy disk drive 32 and an optical disk drive 35. A floppy disk 33 and an optical disk 36 are inserted into the floppy disk drive 32 and the optical disk drive 35, respectively and a predetermined read out operation is carried out, whereby a circuit manufacturing program stored in these storage mediums can be installed into the computer system 30. Further, by connecting an appropriate drive to the computer system 30, the circuit manufacturing program can be installed using a ROM 37 serving as a memory device or a cartridge 38 serving as a magnetic tape device. Also, it is possible to input various types of data on circuit manufacturing through the keyboard 34 and to see the result of circuit place and route processing through the display 31.

Moreover, the circuit design apparatus in this embodiment may be programmed and stored in a computer readable recording medium. If executing the circuit manufacturing program, this recording medium is read by the computer system, the circuit manufacturing program is stored in a recording section such as a memory in the computer system and a processing in the circuit manufacturing program is executed, whereby the circuit manufacturing system and the method thereof in the embodiment according to the present invention can be realized on the computer system. Here, the recording medium means a computer readable medium capable of recording a program such as a semiconductor memory, a magnetic disk, an optical disk, a magneto-optical disk, a magnetic tape, a digital video disk and a communication medium for signals or the like.

### Experimental Example

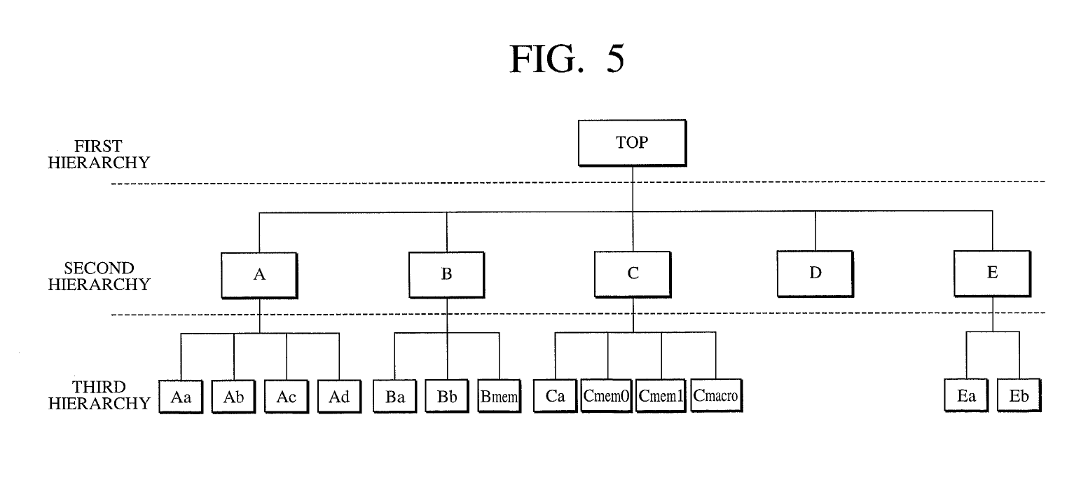

Now, the experimental example of the circuit manufacturing processing in the embodiment according to the present invention will be described with reference to FIGS. 5 to 11 so as to help understand the circuit manufacturing method in the embodiment according to the present invention. It is noted that a circuit having a hierarchical structure shown in FIG. 5 is employed in the description which follows. Namely, this circuit (top) consists of five functional blocks A,B,C,D and E. Each of the functional blocks B and C contains a memory, a macro-cell and two memories. The functional description of the top (first hierarchy) is a connection description for the functional blocks A,B,C,D and E as shown, for example, below:

module TOP ( . . . );

input . . .

output . . . ;

A A ( . . . )

B B ( . . . );

D D ( . . . );

E E ( . . . );

endmodule // TOP

On the other hand, the functional block A (second hierarchy) consists of four blocks Aa, Ab, Ac and Ad and the description thereof is a connection description for the blocks Aa, Ab, Ac and Ad as shown, for example, below:

module A ( . . . );

input . . . ;

output . . . ;

Aa Aa ( . . . );

Ab Ab ( . . . );

Ac Ac ( . . . );

Ad Ad ( . . . );

endmodule // A

Further, in the blocks Aa, Ab, Ac and Ad (third hierarchy), an operation description as required by the functional block A is given. The block Aa is described

shown, for example, below:

| | |
|---|---|
| module Aa (. . .) ; | always @ (. . .) begin |
| input . . . ; | case (. . .) |
| output . . . ; | . . . : . . . ; |
| reg . . . ; | . . . : . . . ; |
| wire . . . ; | . . . : . . . ; |
| always @ (. . .) begin | . . . : . . . ; |
| if (. . .) begin | endcase |
| . . . | end |
| end | assign . . . = . . . ; |
| else | assign . . . = . . . ; |
| . . . | . . . |
| end | endmodule |
| end | |

The above-stated constitution of the functional description is also applied to the functional blocks B,C and E. As for the functional block D (second hierarchy) which does not have sub-blocks, an operation description is given shown, for example, below:

| | |
|---|---|
| module D (. . .) ; | always @ (. . .) begin |
| input . . . ; | case (. . .) |
| output . . . ; | . . . : . . . ; |
| reg . . . ; | . . . : . . . ; |
| wire . . . ; | . . . : . . . ; |
| always @ (. . .) begin | . . . : . . . ; |
| if (. . .) begin | endcase |
| . . . | end |
| end | assign . . . = . . . ; |
| else | assign . . . = . . . ; |
| . . . | . . . |
| end | endmodule |
| end | |

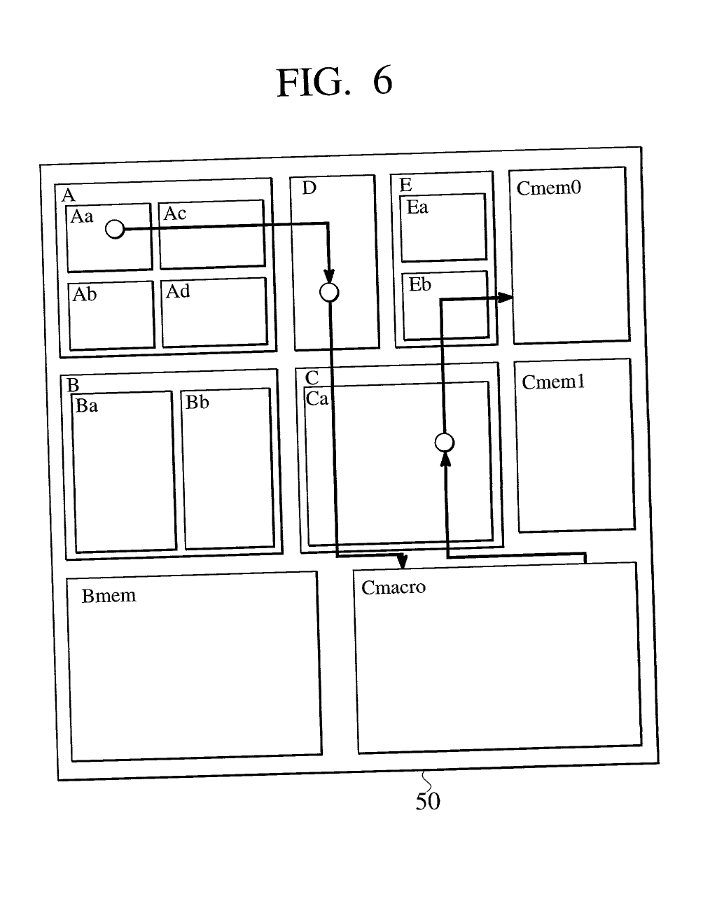

Here, a floor plan in case of conducting a hierarchical layout processing or a flat layout processing using region designation to the circuit information in this state is shown in FIG. 6. As can be seen from FIG. 6, Bmem0, Cmem0, Cmem1 and Cmacro are arranged independently, and the remaining hierarchical structures of A,B,C and E are broken flat. It is noted that FIG. 6 does not show that the blocks Aa, Ab, Ac, Ad, Ba, . . . are arranged therein but shows that the functional block A consists of sub-modules Aa, Ab, Ac and Ad. The same thing is true for the other functional blocks B,C and E. Also, arrows in FIG. 6 indicate an identified critical path as already stated above (in the timing analysis step or S205 ). This critical path indicates a course (Aa _D _Cmacro _Ca _Cmem0) in which a signal from a sequential cell (flip-flop or latch) in which the sub-module Aa is located is inputted into the sub-module Cmacro by way of a logic in which the functional block D is located and the output of the Cmacro is inputted into the sub-module Cmem0 by way of the Ca logic.

Now, a series of circuit manufacturing processings in the embodiment according to the present invention while using the above-stated functional description will be described in due course.

(1) In the circuit manufacturing method in the embodiment according to the present invention, when the above-stated functional description is inputted into the fractionalization unit 111, the fractionalization unit 111 fractionalizes modules in the functional description according to functions, and generates a plurality of new modules before converting the functional description into a gate level.

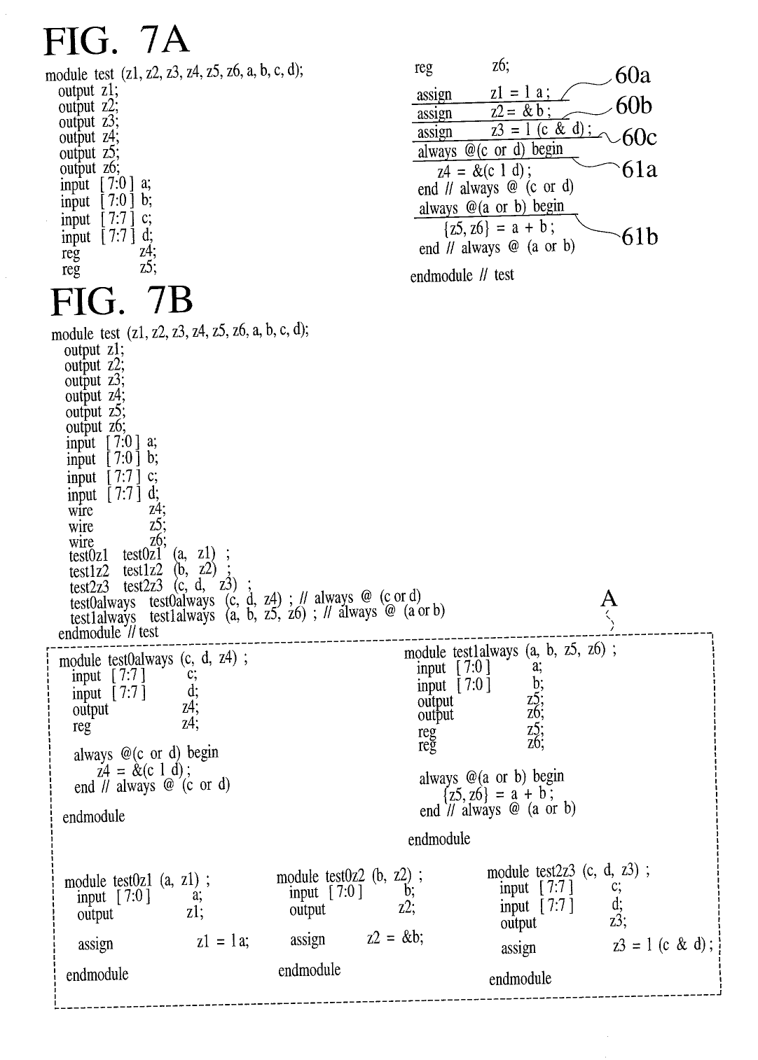

For instance, if the functional description is Verilog-RTL, one or more ‘assign’ sentences 60a, 60b, 60c and one or more ‘always’ blocks 61a and 61b in the description shown in FIG. 7A are retrieved, functions designated in the respective sentences and blocks are fractionalized like description A shown in FIG. 7B and a plurality of new modules are generated.

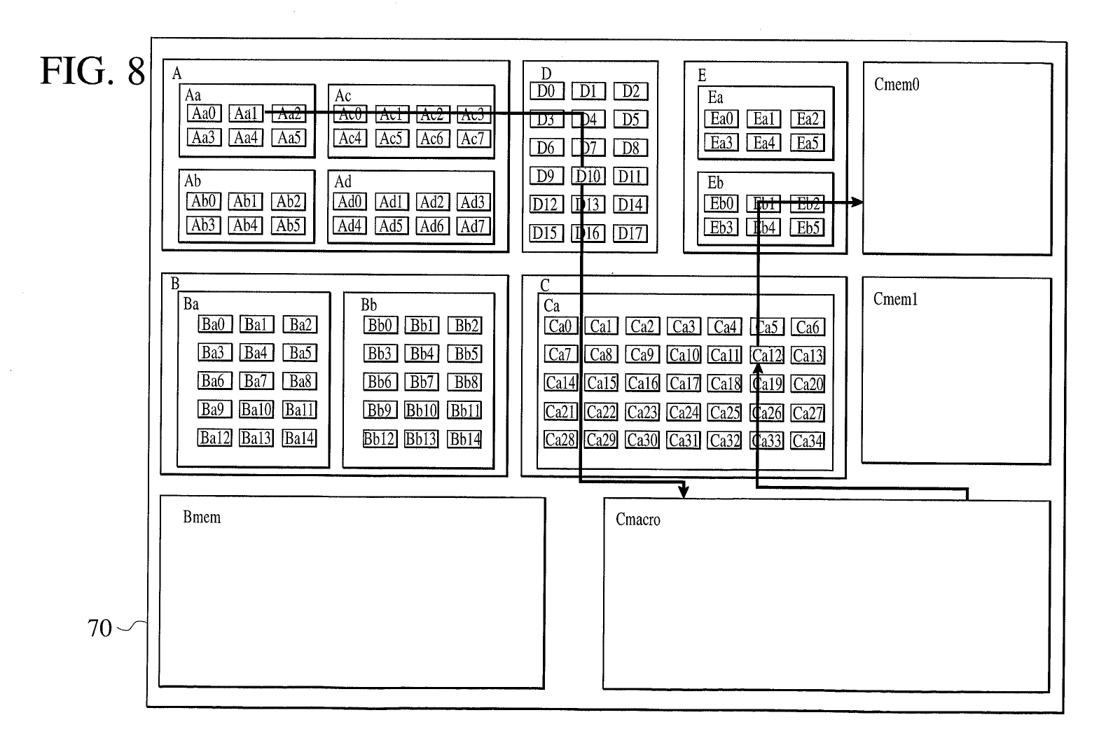

As a result of this processing, the floor plan shown in FIG. 6 turns into a state shown in FIG. 8. In FIG. 8, lowest hierarchical modules Aa, Ab, Ac, Ad, Ba, are fractionalized into a plurality of modules, whereby it is possible to see the course of the critical path in more detail (Aa1 _D10 _Cmacro _Ca12 _Cmem0).

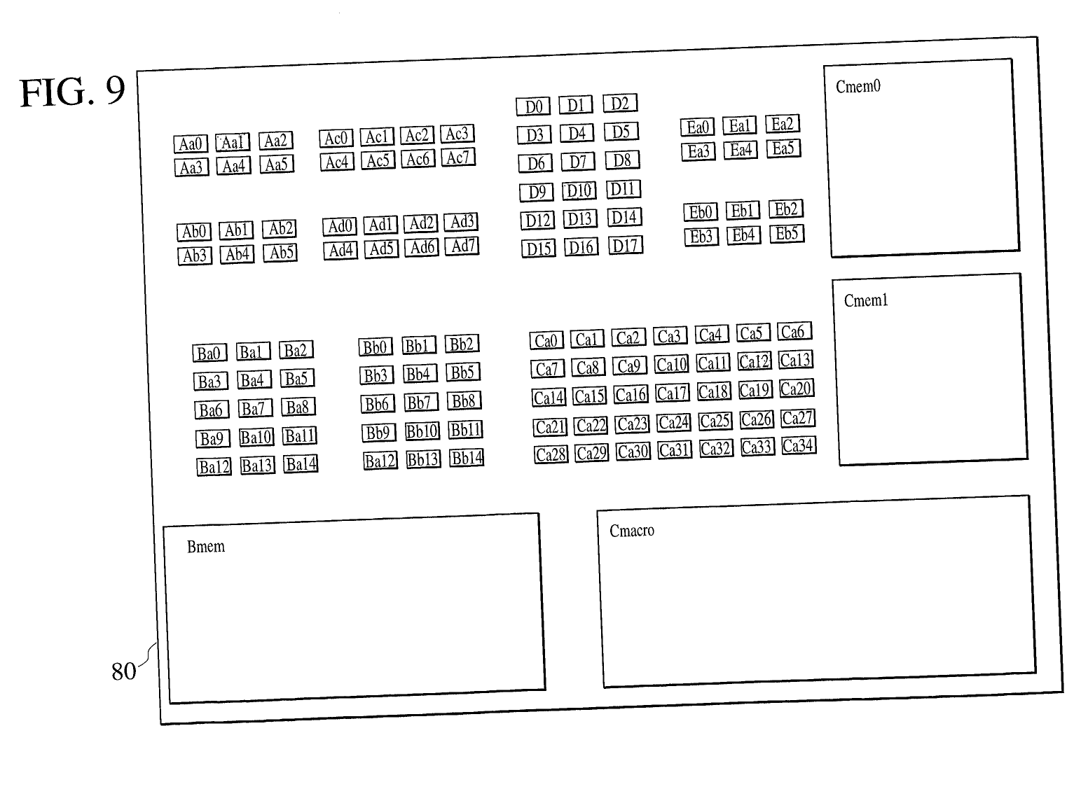

(2) After the completion of the fractionalization processing, the functional description is converted into two hierarchies. When the functional description is converted into two hierarchies, the floor plan shown in FIG. 7 turns into a state shown in FIG. 9. In FIG. 9, the description of the top or the highest hierarchy is a connection description for Bmem, Cmem0, Cmem1, Cmacro, Aa0, Aa1, Aa2, as shown, for example, below:

modele TOP ( . . . );

input . . . ;

output . . . ;

reg . . . ;

wire . . . ;

Bmem Bmem ( . . . );

Cmem0 Cmem0 ( . . . );

Cmem1 Cmem1 ( . . . );

Cmarcro Cmacro ( . . . );

Aa0 Aa0 ( . . . );

Aa1 Aa1 ( . . . );

Aa2 Aa2 ( . . . );

. . .

Ba0 Ba0 ( . . . );

. . .

endmodule

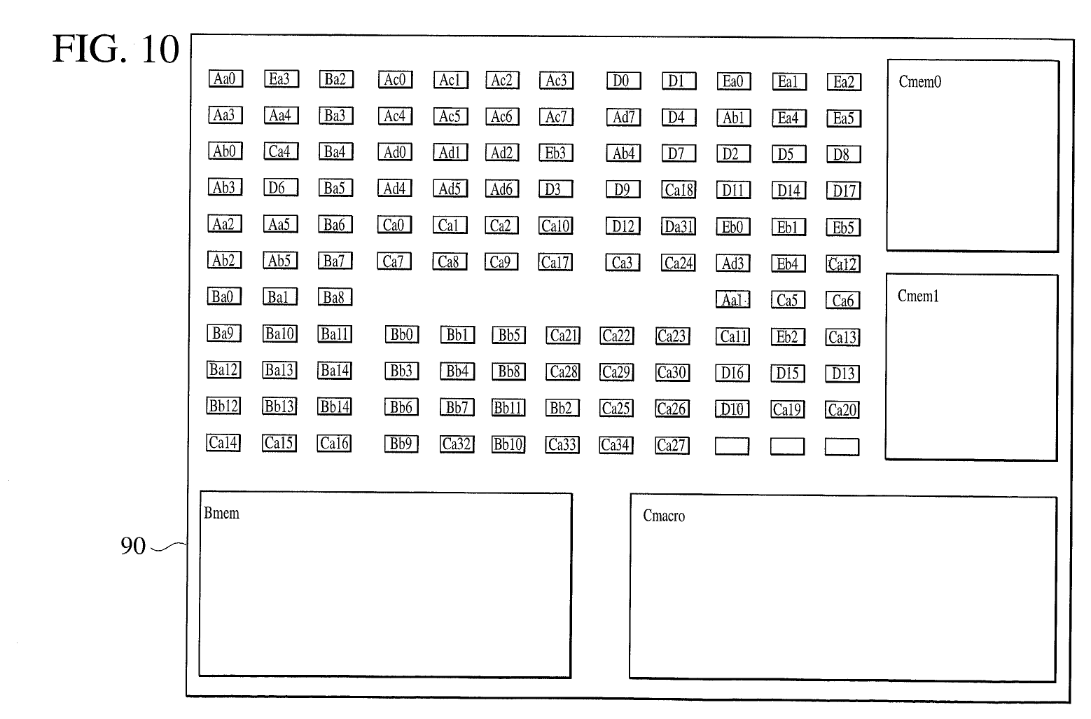

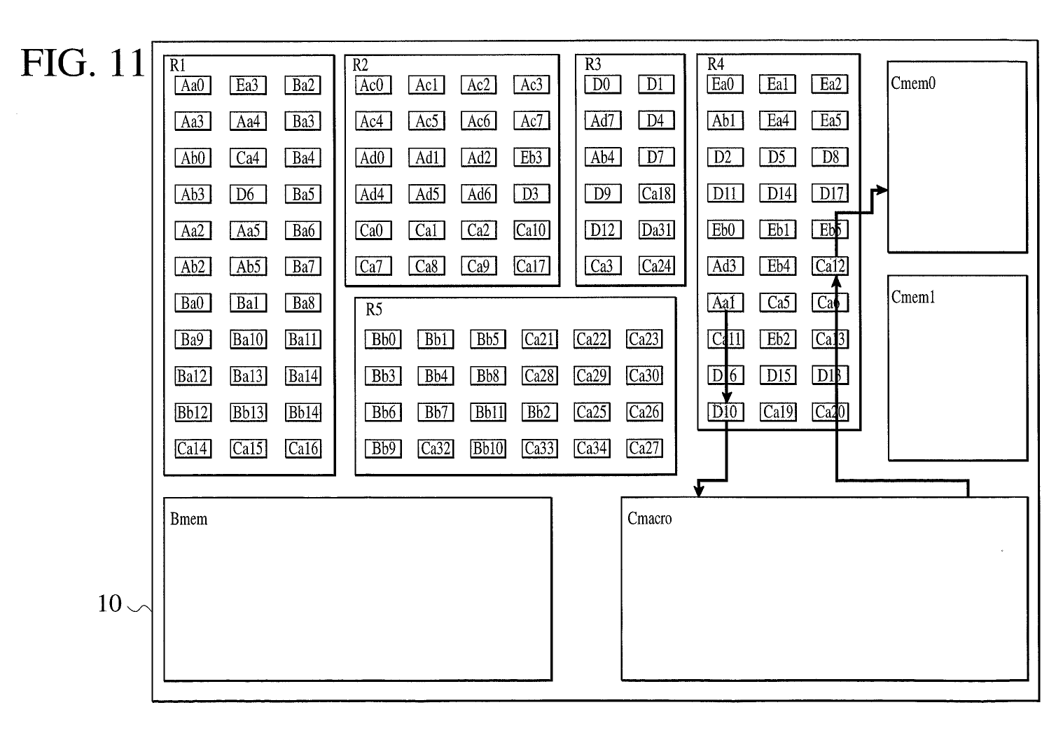

(3) After the completion of the two-hierarchy conversion processing, the fractionalized modules are rearranged while referring to the critical path. As a result of this rearrangement processing, the floor plan shown in FIG. 9 turns into a state shown in FIG. 10. In FIG. 10, the modules Aa0, Aa1, Aa2, . . . not only indicate the constituent elements of the top but also indicate that these modules are arranged in the vicinity of the positions shown therein. As is obvious from FIG. 10, the modules are rearranged while the distances among the modules Aa1, D10 and Ca12 constituting the critical path (Aa1 _D10 _Cmacro _Ca12 _Cmem0) are shortened and the positional relationships with the modules Cmacro and Cmem0 are taken into consideration. (4) After the completion of rearrangement, the fractionalized modules are grouped under a predetermined conditions under which the wire load model works as shown in FIG. 11. In this experimental example, modules Aa0, Aa1, Ba2, Aa3, Aa4, Ba3, Ab0, . . . , modules Ac0, Ac1, . . . , Ad0, Ad1, . . . ; Ca0, . . . , modules D0, D1, . . . , Ca31, Ca3, Ca24, modules Ea0, Ea1, . . . , D2, D5, . . . , Eb0, . . . , and modules Bb0, Bb1, Bb5, Ca21, Ca22, Ca23, . . . are grouped together into new modules R1, R2, R3, R4, R5, respectively.

As stated so far, according to the circuit manufacturing method in the embodiment according to the present invention, the wire length of the critical path considerably shortened and it is, therefore, possible to suppress the formation of the critical path. In addition, it is possible to minimize the wire lengths among memories, IP and sub-modules in this path. Besides, while there has been no way to know detailed information on the course of the critical path as to, for example, which portions in the modules the critical path follows, it is possible to specify ‘always’ blocks and ‘assign’ sentences constituting the critical path as to, for example, which portions of the module Aa according to the circuit manufacturing method in the embodiment according to the present invention. Thus, it is possible to conduct a detailed analysis to the critical path and to thereby execute a place and route processing in which the critical path has been improved.

### Other Embodiments

Various modifications will become possible for those skilled in the art after receiving the teachings of the present disclosure without depending from the scope thereof.

What is claimed is:

1. A logical synthesis apparatus comprising:
a fractionalization unit for fractionalizing a module defined in a hardware functional description according to functions, and for generating fractionalized modules;
a hierarchical unit for converting said hardware functional description into two hierarchies;
a rearrangement unit for rearranging said fractionalized modules so as to decrease detoured wires and long wires;
a grouping unit for grouping said rearranged fractionalized modules under a predetermined condition under which a wire load model works, and for generating an intermediate hierarchy in said hardware functional description converted into two hierarchies; and
a unit for conducting logical synthesis processing to said hardware functional description in which the intermediate hierarchy has been generated.

2. The logical synthesis apparatus according to claim 1, further comprising:
a timing analysis unit for identifying a critical path formed in a circuit, wherein
said fractionalized modules are rearranged while referring to information on the critical path.

3. The logical synthesis apparatus according to claim 1, wherein said grouping is conducted so as to reduce the number of wires on the intermediate hierarchy.

4. The logical synthesis apparatus according to claim 2, wherein said grouping is conducted so as to reduce the number of wires on the intermediate hierarchy.

5. A logical synthesis method comprising the steps of:
a fractionalization processing step of fractionalizing a module defined in a hardware functional description according to functions, and of generating fractionalized modules;
a hierarchical processing step of converting said hardware functional description into two hierarchies;
a rearrangement processing step of rearranging said fractionalized modules so as to decrease detoured wires and long wires;
a grouping processing step of grouping said rearranged fractionalized modules under a predetermined condition under which a wire load model works, and of generating an intermediate hierarchy in said hardware functional description converted into two hierarchies; and
a step of conducting logical synthesis processing to said hardware functional description in which the intermediate hierarchy has been generated.

6. The logical synthesis method according to claim 5, further comprising the steps of:
a timing analysis step of identifying a critical path formed in a circuit, wherein
said fractionalized modules are rearranged while referring to information on the critical path.

7. The logical synthesis method according to claim 5, wherein said grouping is conducted so as to reduce the number of wires on the intermediate hierarchy.

8. The logical synthesis method according to claim 6, wherein said grouping is conducted so as to reduce the number of wires on the intermediate hierarchy.

9. A logical synthesis program product for converting a hardware functional description into gate-level circuit information comprising:
a computer readable program code for fractionalizing a module defined in a hardware functional description according to functions, and for generating fractionalized modules;
a computer readable program code for converting said hardware functional description into two hierarchies;
a computer readable program code for rearranging said fractionalized modules so as to decrease detoured wires and long wires;
a computer readable program code for grouping said rearranged fractionalized modules under a predetermined condition under which a wire load model works, and for generating an intermediate hierarchy in said hardware functional description converted into two hierarchies; and
a computer readable program code for conducting logical synthesis to said hardware functional description in which the intermediate hierarchy has been generated.

10. A logical synthesis apparatus comprising:
a fractionalization unit for fractionalizing a module defined in a hardware functional description according to functions, and for generating fractionalized modules;
a rearrangement unit for rearranging said fractionalized modules so as to decrease detoured wires and long wires; and
a unit for conducting a logical synthesis processing to said rearranged hardware functional description.

11. A logical synthesis method comprising the steps of:
a fractionalization processing step of fractionalizing a module defined in a hardware functional description according to functions, and of generating fractionalized modules;
a rearrangement processing step of rearranging said fractionalized modules so as to decrease detoured wires and long wires; and
a step of conducting a logical synthesis processing to said rearranged hardware functional description.

12. A logical synthesis program product for converting a hardware functional description into gate-level circuit information comprising:
a computer readable program code for fractionalizing a module defined in a hardware functional description according to functions, and for generating fractionalized modules;
a computer readable program code for rearranging said fractionalized modules so as to decrease detoured wires and long wires; and
a computer readable program code for conducting a logical synthesis processing to said rearranged hardware functional description.

13. A circuit manufacturing method of determining a layout in a circuit by conducting a logical synthesis, optimization processing and a place and route processing to a hardware functional description, and manufacturing the circuit using layout information, the method comprising the steps of:
a fractionalization processing step of fractionalizing a module defined in a hardware functional description according to functions, and of generating fractionalized modules;
a hierarchical processing step of converting said hardware functional description into two hierarchies;
a rearrangement processing step of rearranging said fractionalized modules so as to decrease detoured wires and long wires;
a grouping processing step of grouping said rearranged fractionalized modules under a predetermined condition under which a wire load model works, and of generating an intermediate hierarchy in said hardware functional description converted into two hierarchies;
a step of determining the layout in a circuit by conducting logical synthesis processing, optimization processing, and a place and route processing to said hardware functional description in which the intermediate hierarchy has been generated ; and
a step of manufacturing the circuit using the determined layout information.
